(19) United States
(12) Patent Application Publication
(10) Pub. No.: US 2021/0079664 A1
(43) Pub. Date: Mar. 18, 2021

(54) CLADDING PANELS AND THEIR METHODS OF ASSEMBLY

(71) Applicant: Abdalla Zoabi, Nazareth (IL)

(72) Inventor: Abdalla Zoabi, Nazareth (IL)

(21) Appl. No.: 17/042,320

(22) PCT Filed: Mar. 27, 2019
(86) PCT No.: PCT/US19/24261

§ 371 Date: Sep. 28, 2020

Related U.S. Application Data
(60) Provisional application No. 62/648,474, filed on Mar. 27, 2018.

(51) Int. Cl. E04F 13/14; B32B 25/04; B32B 3/08; B32B 9/00; B32B 9/04; B32B 7/12; B32B 7/08

(52) U.S. Cl. CPC E04F 13/147; B32B 25/045; B32B 3/08; B32B 9/002; B32B 2307/102; B32B 7/12; B32B 7/08; B32B 2272/00; B32B 9/043

(57) ABSTRACT

The disclosure is directed to non-loadbearing construction panels. More particularly, the disclosure is directed to a thermally, acoustically and moisture insulated cladding panels with natural stone façade coupled to recycled rubber layer, configured to slidably couple to dedicated bracket(s).

### BACKGROUND

The disclosure generally relates to non-load-bearing construction panels. More particularly, the disclosure relates to a thermally, acoustically and moisture insulated cladding panels with natural stone façade coupled to recycled rubber and their assembly.

Most modern residential and light commercial designs use platform framing, which involves poured in place column-and-slab techniques or skeletonized construction employing a framework of steel girders as a support for precast concrete members.

Furthermore, additional measures for heat insulation and sound insulation are incorporated both on the finished internal surface and external weather resistant layers. In certain circumstances, these include various types of cladding.

Many cladding materials, such as timber, vinyl, and fiber cement have been used in plank or weatherboard form to construct exterior wall assemblies on buildings. Typically, each piece of such cladding material is installed so that its lower edge covers the fixing positions of the previously installed piece. The location, strength, and configuration of the anchor provide the resistance of the wall assembly to applied loads, such as wind loads.

When cladding requires carved, natural stone façade, either by architects or regulation, to maintain consistency (e.g., with other structures in the area) or due to conservation consideration (e.g., zoning requirements), constraints on construction may become significant.

These and other issues are addressed by the following disclosure.

### SUMMARY

Disclosed, in various embodiments, are stone façade cladding panels coupled to recycled rubber layer, that are thermally, acoustically and moisture insulated, which are additionally compliant with fire resistance regulations.

In an embodiment, provided herein is cladding panel having an apical plane and a basal plane, the cladding panel comprising: a stone layer having a rough external side and a smooth internal side; and a recycled rubber layer adhesively and mechanically coupled to the smooth internal side of the stone layer, wherein the panel is configured to be slidably coupled to an apical bracket, the apical bracket being mechanically coupled to the external side of a weight bearing structure such as a wall or a skeletal structure.

In an embodiment, the apical bracket has L-shaped cross section, with a short leg mechanically coupled to the external side of the weight-bearing structure such as a wall or a skeletal structure, and a long leg configured to engage the apical plane of the cladding panel.

In yet another embodiment, the apical plane of the cladding panel further defines a first channel configured to engage a first rail protruding basally from the long leg of the L-shape cross section of the apical bracket.

These and other objectives and advantages of the present technology will become understood by the reader and it is intended that these objects and advantages are within the scope of the technology disclosed and claimed herein. To the accomplishment of the above and related objects, this disclosure may be embodied in the form illustrated in the accompanying drawings, attention being called to the fact, however, that the drawings are illustrative only, and that changes may be made in the specific construction illustrated and described within the scope of the disclosure.

### BRIEF DESCRIPTION OF THE FIGURES

For a better understanding of the thermally, acoustically and moisture insulated cladding panels with natural stone façade coupled to recycled rubber, reference is made to the accompanying drawings, in which like numerals designate corresponding elements or sections throughout and in which:

FIG. 1A, is an isometric schematic of an embodiment of the cladding panel with enlarged section A illustrated in FIG. 1B;

FIG. 2A is a X-Z cross section of a first embodiment of the cladding panel coupling to the structure such as a wall or a skeletal structure having a single channel-rail coupling, with FIG. 2B, illustrating a X-Z cross section of a second embodiment of the cladding panel coupling to the structure such as a wall or a skeletal structure having a plurality (2 shown, could be more) of channel-rail coupling configuration;

FIG. 3A is a X-Z cross section of enlarged region B in FIGS. 2A, 2B, of apical (or basal) L-shaped bracket illustrated configured to engage the cladding panel of FIG. 2A, with FIG. 3B, illustrating the X-Z cross section of the apical (or basal) L-shaped bracket configured to engage the cladding panel of FIG. 2B; and

FIGS. 4A-4B is a schematic flow chart detailing an embodiment of the methods provided.

### DESCRIPTION

Provided herein are embodiments of thermally, acoustically and moisture insulated cladding panels with natural stone façade coupled to recycled rubber and methods for their use.

A more complete understanding of the components, methods, and devices disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof, their relative size relationship and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Likewise, cross sections are referred to on normal orthogonal coordinate apparatus having XYZ axis, such that Y axis refers to front-to-back, X axis refers to side-to-side, and Z axis refers to up-and-down.

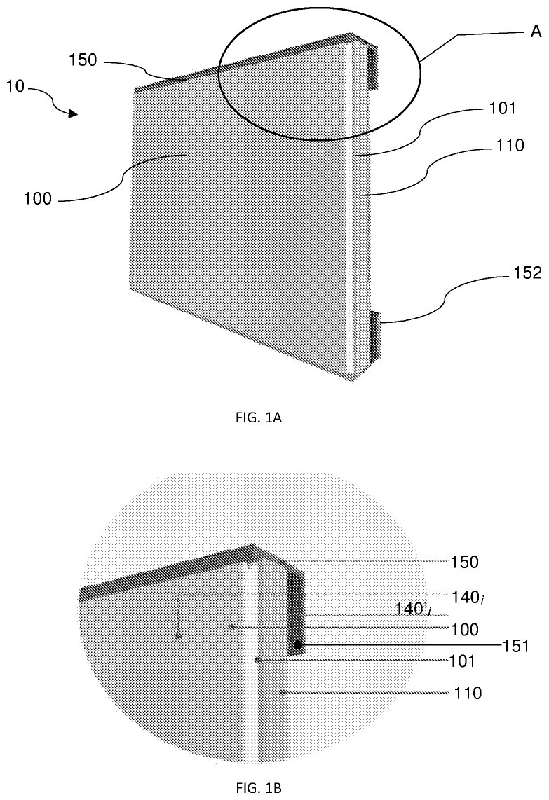

Turning now to FIGS. 1A-1B, illustrating in FIG. 1A, an isometric schematic of an embodiment of the cladding panel with enlarged section ‘A’ illustrated in FIG. 1B. As illustrated, provided herein is cladding panel 10 having apical plane 150 and a basal plane 150′, cladding panel 10 comprising: stone layer 100 having a rough external (away from the rubber layer 110) side and a smooth internal side; and recycled rubber layer 110 adhesively (see e.g., glue layer 101 and mechanically coupled to the smooth internal side of stone layer 100, wherein cladding panel 10 is configured to be slidably coupled to an apical bracket 151 (see e.g., FIG. 1B), apical bracket 151 being mechanically coupled to the external side 501 of weight bearing wall 500. The term “rough” side as used herein means the external layer having a roughness in the range of about 2 mm root mean square (rms) to about 10 mm rms, while the term “smooth” side, in reference to both the stone layer and the smooth side of rubber layer 110, means having roughness of no more than about 1.5 mm rms.

As shown in FIG. 1B, apical bracket 151 having L shape is configured to couple to the external side 501 of load bearing wall 500. Fixing means 140, (not shown) physically couple recycled rubber layer 110 to natural stone layer 100, such that the recycled rubber layer 110 and (natural) stone layer 110 are mechanically coupled using no less than four mechanical coupling means for every 0.09 m². In other words, regardless of the size of cladding panel 10, a grid of 30 cm.×30 cm. can be created in an embodiment whereby mechanical coupling means (e.g., a screw, or an anchor) 140, is inserted mechanically, coupling (natural) stone layer 100 to recycled rubber layer 110, through adhesive layer 101. Mechanical coupling means, as used herein, is a broad term referring in an embodiment to its ordinary dictionary definition and also refers to nails, screws, detents, bosses, anchors, etc. In an embodiment, the mechanical coupling means can be, for example, a galvanized screw, a stainless-steel screw, toggle bolt screw, snap bolt screw or a coupling means combination comprising the foregoing. Furthermore, “cladding” as used herein is a broad term and includes its ordinary dictionary definition to construct wall assemblies on buildings and/or rooves. Other shapes and materials can be used as well.

As indicated, rubber layer 110 is a recycled rubber layer having properties unique to its use in cladding panel 10. Accordingly, and in an embodiment, the recycled rubber layer 110 used in the cladding panels provided herein, and mechanically coupled to (natural) stone layer 100 can be fabricated to have a smooth side configured to abut the smooth internal side of (natural) stone layer 100. When mechanically coupled, recycled rubber layer 110 can be configured a bond test of no less than 0.1 KN. The test is conducted according to the bond testing method, whereby a test piece is made by applying an adhesive and a mechanical coupling means, to the central part of a 7 cm×7 cm bond testing piece formed of the stone layer, and bonding thereto an attachment (4 cm×4 cm in section) for tensile test. This test piece is set in a bond tester and pulled in the direction normal to the surface at 23° C. environment, and the maximum tensile load (Newton) at break is read while observing the condition of break. The read value is divided by the area (16 cm²) and the quotient is expressed as bond strength (N). The above test is conducted on a plurality (−4) test pieces for each specimen and the mean value is determined and reported.

Furthermore, the smooth side of the recycled rubber layer is configured to abut the smooth side of the stone layer, through the adhesive and still maintain at least one of a static and dynamic (in other words, static and/or dynamic) friction coefficient between rubber layer 110 and (natural) stone layer 100, of between 0.05 and about 2.0. The density of recycled rubber layer 110 can be configured to be between about 50 Kg/m³ and about 3000 Kg/m³, and will depend on the environmental conditions and the desired insulation. In other words, density may increase for increased acoustic insulation and decreased for thermal insulation.

In addition, the compression strength (in other words, the maximum compressive load the cladding panel can bear prior to failure, divided by its cross sectional area) of the recycled rubber layer used in the cladding panels described herein, can be fabricated to be between about 0.5 MPA and about 100 MPA. The compression strength is a factor in certain embodiment that will affect the height at which the cladding panel can be positioned, where wind loads may require compression of the panel due to regulation pertaining to the use of stones as an external façade materials. This may be exacerbated on earthquake-prone regions.

A choice of source rubber for the recycled rubber layer can be configured to yield a targeted thermal conductivity, which would affect the efficacy of the cladding panel in its use as a thermal insulator. Accordingly and in an embodiment, the thermal conductivity of the recycled rubber s between about 0.02 W/Mk and about 2.2 W/Mk.

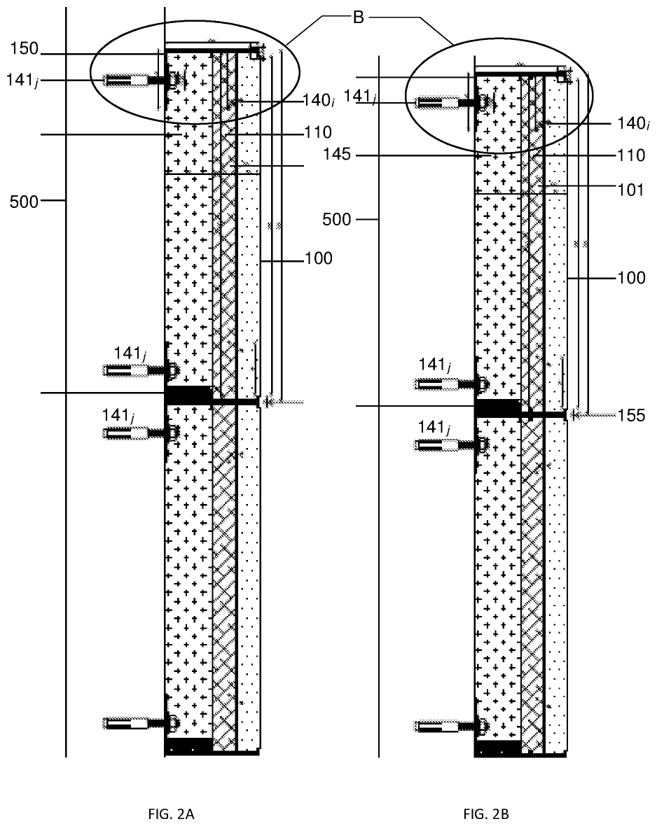

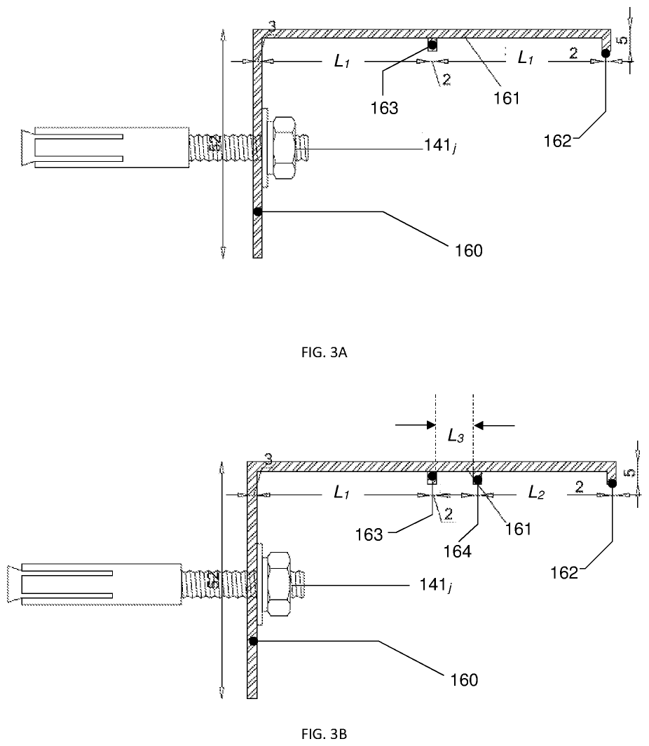

Turning now to FIGS. 2A, 2B, illustrating, with FIGS. 3A, 3B, the assembly of cladding panel 10 on wall 500, with external wall side 501. As illustrated in FIG. 2A (and corresponding apical bracket 150_{A}, FIG. 3A) L-shaped bracket 150A is mechanically coupled to wall 500 external side 501 via mechanical coupling means 141j, in this case, cement board screw anchor, although others may be used depending on the cladding panel weight and wall 500 construction material e.g. Although the term “L-shaped” is used to describe the shape of the apical and/or basal bracket(s), with the vertical portion 160 (see e.g., FIG. 3A of bracket 150_{A}, intersecting the horizontal portion 161 of the bracket, there is not requirement that the bracket(s) be exactly the shape of an “L”. For example, sharp corners are not required, nor a perpendicular orientation between the vertical leg 160 and the horizontal leg 161. Accordingly bracket 150_{A}, is coupled to wall 500 external face 501 through vertical leg 160, using mechanical coupling means 141j. As illustrated, bracket(s) 150_{A}, and/or 150_{B}, both define distal lip 162 disposed at the distal end of horizontal leg 161 of bracket(s) 150_{A}, and/or 150_{B}. Distal lip 162 is configured to engage shelf 105 (see e.g., FIGS. 1B, 2A, 2B) defined in stone layer 100, when panel 10 is slidably coupled to bracket bracket(s) 150_{A}, and/or 150_{B}. In an embodiment, the term “slidably coupled” refers to elements (e.g., distal lip 162 and the shelf 105), which are coupled in a way that permits one element (e.g., shelf 105) to slide or translate with respect to another element (e.g., distal lip 162). In addition, at distance Li rail 163 is defined, which protrude basally from horizontal leg 161, and configured to engage a complimentary channel (not shown) defined on the apical facet of cladding panel 10, in recycled rubber layer 110. As illustrated in FIG. 3A, rail 163 can be disposed equidistance between distal lip 162 and vertical leg 160.

Turning now to FIGS. 1B, 2B, and 3B, illustrating bracket 150_{B}, defining a plurality of rails 163, 164, protruding basally from horizontal leg 161, and are configured to engage complimentary channels (not shown), one in (natural) stone layer 100 and another in recycled rubber layer 110, upon sliding of cladding panel 10 into bracket 150_{B}. The protrusion of rails 163, 164 is not necessarily the same and rail 164 may be configured to protrude less end engage a shallower channel defined in (natural) stone layer 100. This may be advantageous in circumstances where the natural stone layer 100 is made of a relatively weaker stone.

Also shown in FIGS. 2A, 2B, is insulation foam 145 which can optionally be installed and abut recycled rubber layer 110, as well as spacer 146 separating insulating foam panels 145. Cladding panel(s) can be configured to have space 155, allowing for example, for drainage of and condensed moisture trapped between insulation foam panel(s) 145, and recycled rubber layer 110 of cladding panel 10.

In an embodiment, cladding panel 10 can further be configured to be slidably coupled to a second, basal bracket 152 (see e.g., FIG. 1A), basal bracket 152 being mechanically coupled to external side 501 of a weight bearing wall 500 and be identical to apical bracket 150, or different (in other words, 150_{A}, or 150_{B}). When basal bracket 152 is implemented, cladding panel 10 is fabricated with the complimentary channels and basal distal lip (see e.g., 105′, FIG. 1A), to allow for cladding panel 10 to slidably couple to the apical and basal brackets.

### Example I—Cladding Panel Properties

The recycled rubber is directly glued and fixed to the first external layer (stone) using construction adhesive and 4 nails/screws.
The rubber layer thickness is between: 3 mm-500 mm.
The stone thickness is between: 5 mm-100 mm.
The recycled rubber plate is configured to have a fire rating that is between C1-C4, and/or between A-E and/or between I-IV according to the Israeli codes 921 and 755.

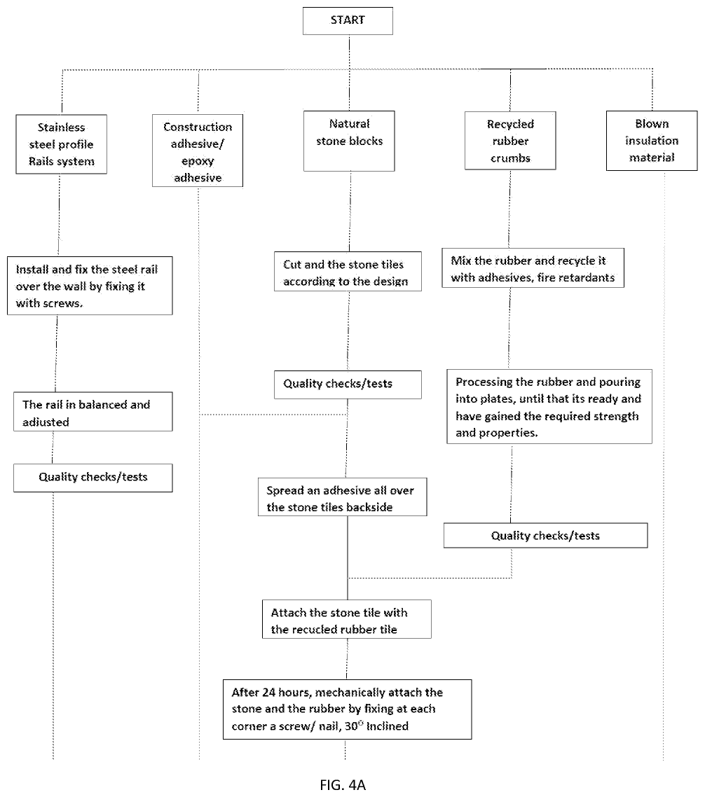

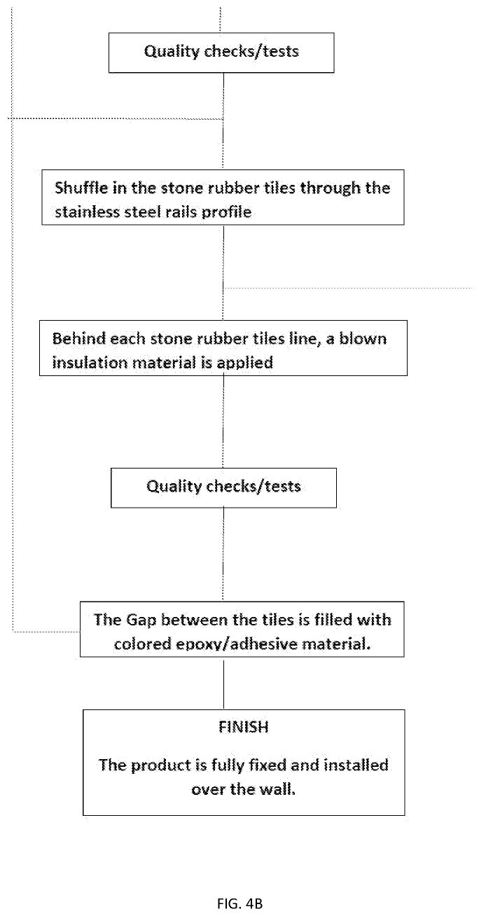

A flowchart detailing the operations used in order to implement the cladding panel(s) disclosed herein, is shown schematically in FIGS. 4A-4B.

The term “coupled”, including its various forms such as “operably coupling”, “coupling” or “couplable”, refers to and comprises any direct or indirect, structural coupling, connection or attachment, or adaptation or capability for such a direct or indirect structural or operational coupling, connection or attachment, including integrally formed components and components which are coupled via or through another component or by the forming process. Indirect coupling may involve coupling through an intermediary member or adhesive, or abutting and otherwise resting against, whether frictionally or by separate means without any physical connection

The term “about”, when used in the description of the technology and/or claims means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such and may include the end points of any range provided including, for example ±25%, or ±20%, specifically, ±15%, or ±10%, more specifically, ±5% of the indicated value of the disclosed amounts, sizes, formulations, parameters, and other quantities and characteristics.

The terms “first,” “second,” and the like, herein do not denote any order, quantity, or importance, but rather are used to denote one element from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the bracket(s) includes one or more bracket). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Accordingly and in an embodiment, provided herein is a cladding panel having an apical plane and a basal plane comprising: a stone layer having a rough external side and a smooth internal side; and a recycled rubber layer adhesively and mechanically coupled to the smooth internal side of the stone layer, wherein the panel is configured to be slidably coupled to an apical bracket, the apical bracket being mechanically coupled to the external side of a weight bearing wall, wherein (i) the recycled rubber layer has a smooth side configured to abut the smooth internal side of the stone layer, and (ii) is configured to pass a bond test of no less than 0.1 kN, wherein (iii) the at least one of the static and friction coefficient between the recycled rubber layer and the stone layer is between about 0.05 and about 2.0, (iv) the density of the recycled rubber layer is between about 50 Kg/m³ and about 3000 Kg/m³, further (v) further comprising an adhesive layer sandwiched between the recycled rubber layer and the stone layer, providing the adhesive coupling, wherein (vi) the recycled rubber layer and the stone layer are mechanically coupled using no less than four mechanical coupling means for every 0.09 m², wherein (vii) the mechanical coupling mean is at least one of a galvanized screw, a stainless-steel screw, toggle bolt screw, and snap bolt screw, (viii) the compression strength of the recycled rubber layer is between about 0.5 MPA and about 100 MPA, wherein (ix) the thermal conductivity of the recycled rubber s between about 0.02 W/Mk and about 2.2 W/Mk, wherein (x) the apical bracket has L-shaped cross section, with a short leg mechanically coupled to the external side of the weight-bearing wall, and a long leg configured to engage the apical plane of the panel, (xi) the apical plane of the panel further defines a first channel configured to engage a first rail protruding basally from the long leg of the L-shape cross section of the apical bracket, and (xii) the apical plane of the panel further defines a second channel configured to engage a second rail protruding basally from the long leg of the L-shape cross section of the apical bracket, wherein (xiii) the panel is further configured to be slidably coupled to a basal bracket, the basal bracket being mechanically coupled to the external side of a weight bearing wall, (xiv) the basal bracket has L-shaped cross section, with a short leg mechanically coupled to the external side of the weight-bearing wall, and a long leg configured to engage the basal plane of the panel, (xv) further defining a first channel configured to engage a first rail protruding basally from the long leg of the L-shape cross section of the basal bracket, and wherein (xvi) the basal plane of the panel further defines a second channel configured to engage a second rail protruding basally from the long leg of the L-shape cross section of the basal bracket.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A cladding panel having an apical plane and a basal plane comprising:
a. a stone layer having a rough external side and a smooth internal side; and
b. a recycled rubber layer adhesively and mechanically coupled to the smooth internal side of the stone layer, wherein the panel is configured to be slidably coupled to an apical bracket, the apical bracket being mechanically coupled to the external side of a weight bearing wall.

2. The panel of claim 1, wherein the recycled rubber layer has a smooth side configured to abut the smooth internal side of the stone layer.

3. The panel of claim 1, wherein the recycled rubber layer is configured to pass a bond test of no less than 0.1 kN.

4. The panel of claim 2, wherein the at least one of the static and friction coefficient between the recycled rubber layer and the stone layer is between about 0.05 and about 2.0.

5. The panel of claim 3, wherein the density of the recycled rubber layer is between about 50 Kg/m³ and about 3000 Kg/m³.

6. The Panel of claim 1, further comprising an adhesive layer sandwiched between the recycled rubber layer and the stone layer, providing the adhesive coupling.

7. The panel of claim 6, wherein the recycled rubber layer and the stone layer are mechanically coupled using no less than four mechanical coupling means for every 0.09 m².

8. The panel of claim 7, wherein the mechanical coupling mean is at least one of a galvanized screw, a stainless-steel screw, toggle bolt screw, and snap bolt screw.

9. The panel of claim 5, wherein the compression strength of the recycled rubber layer is between about 0.5 MPA and about 100 MPA.

10. The panel of claim 9, wherein the thermal conductivity of the recycled rubber s between about 0.02 W/Mk and about 2.2 W/Mk.

11. The panel of claim 1, wherein the apical bracket has L-shaped cross section, with a short leg mechanically coupled to the external side of the weight-bearing wall, and a long leg configured to engage the apical plane of the panel.

12. The panel of claim 11, wherein the apical plane of the panel further defines a first channel configured to engage a first rail protruding basally from the long leg of the L-shape cross section of the apical bracket.

13. The panel of claim 11, wherein the apical plane of the panel further defines a second channel configured to engage a second rail protruding basally from the long leg of the L-shape cross section of the apical bracket.

14. The panel of claim 12, wherein the panel is further configured to be slidably coupled to a basal bracket, the basal bracket being mechanically coupled to the external side of a weight bearing wall.

15. The panel of claim 1, wherein the basal bracket has L-shaped cross section, with a short leg mechanically coupled to the external side of the weight-bearing wall, and a long leg configured to engage the basal plane of the panel.

16. The panel of claim 11, wherein the basal plane of the panel further defines a first channel configured to engage a first rail protruding basally from the long leg of the L-shape cross section of the basal bracket.

17. The panel of claim 11, wherein the basal plane of the panel further defines a second channel configured to engage a second rail protruding basally from the long leg of the L-shape cross section of the basal bracket.
